(19) United States
(12) Patent Application Publication
(10) Pub. No.: US 2005/0053359 A1
(43) Pub. Date: Mar. 10, 2005

(54) Information storage medium storing scenario, apparatus and method of recording the scenario on the information storage medium, apparatus for reproducing data from the information storage medium, and method of searching for the scenario

(75) Inventors: Kil-soo Jung, Hwaseong-si (KR); Jung-wan Ko, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/898,542

(22) Filed: Jul. 26, 2004

(30) Foreign Application Priority Data
Jul. 24, 2003 (KR) 2003-51105
Nov. 10, 2003 (KR) 2003-79243

(51) Int. Cl. H04N 5/781

(52) U.S. Cl. 386/95; 386/125

(57) ABSTRACT

An invention relating to an information storage medium that stores a movie scenario written in a markup language to make a movie scenario database and to provide a user interface for searching the movie scenario database, an apparatus for reproducing data from the information storage medium, a method of searching the movie scenario, and an apparatus and method of recording audio/video (AV) data including the scenario in the information storage medium. The movie scenario includes elements indicating components of the scenario and attributes indicating detailed information about the elements. Each of the elements is used upon a search of the scenario. Accordingly, a scenario and/or a conti are written in a markup language for movie scripts, so more various pieces of information are provided to a user.

### CROSS-REFERENCE TO RELATED APPLICATION

This application claims the benefit of Korean Patent Application Nos. 2003-51105, filed on Jul. 24, 2003, and 2003-79243, filed on Nov. 10, 2003, in the Korean Intellectual Property Office, the disclosures of which are incorporated herein by reference.

### BACKGROUND OF THE INVENTION

1. Field of the Invention

The present invention relates to information storage and reproduction, and more particularly, to an information storage medium that stores a movie scenario written in a markup language to make a movie scenario database and to provide a user interface for searching the movie scenario database, an apparatus for reproducing data from the information storage medium, a method of searching the movie scenario, and an apparatus and method of recording audio/video (AV) data, including the scenario in the information storage medium.

2. Description of the Related Art

Movie scripts and subtitles are generally displayed on a screen by converting the movie scripts and subtitles into graphic data. Alternatively, subtitles may be displayed using a markup language. However, when such conventional methods are used to process interactive contents for interactions with users, a large amount of data must be processed, and the contents of a script are difficult to search.

FIG. 1 is a block diagram of a structure of a video object set (VOBS) 100, which is encoded moving picture data recorded on a digital video display (DVD). The VOBS 100 is divided into a plurality of video objects (VOBs) 110a through 110n. Each of the VOBs 110a through 110n is divided into a plurality of cells 120a through 120n. Each of the cells 120a through 120n includes a plurality of video object units (VOBUs) 130a through 130n. Each of the VOBUs 130a through 130n includes a plurality of packs (PCKs), of which a first PCK is a navigation PCK (NV_PCK) 140. The PCKs include at least a video pack (V_PCK) 144, an audio pack (A_PCK) 142, and a sub picture pack (SP_PCK) 146, in addition to the NV_PCK 140. The SP_PCK 146 is an area for storing two-dimensional graphics data and subtitle data. The graphics data is referred to as a subpicture.

In DVDs, subtitle data to be displayed overlapping an image is encoded using the same method as a method of encoding two-dimensional graphics data. Hence, separate encoding methods for different languages do not exist, such as to support languages from various countries. Instead a single encoding method is used to encode graphics data into which subtitle data is converted. The encoded graphics data is recorded in the SP_PCK 146. A subpicture includes subpicture units (SPUs) and corresponds to a sheet of graphics data.

Subpictures for subtitle data of a maximum of 32 languages may be multiplexed together with moving picture data and recorded on DVDs. As illustrated in FIG. 1, subtitle data of DVD-Video is multiplexed with moving picture data, thus causing many problems. One of the problems is that the amount of bits occupied by subpicture data must be considered before encoding of moving picture data. In other words, since subtitle data is converted into graphics data before being encoded, if a subtitle in many languages is wanted, different amounts of data for different languages are generated, and the amounts of generated data are vast. Thus, multiplexing the subtitle data with moving picture data is difficult.

Even when a subtitle is supported by many languages, moving picture encoding is generally performed once, and subpicture data for each language is preferably multiplexed with an encoded stream to make a storage medium suitable for each region. As for some languages, the amount of subpicture data is vast, so the total amount of bits generated upon multiplexing with moving picture data may exceed a maximum limit to which data can be recorded in a DVD. Also, since the subpicture data is multiplexed in order to be interposed in between moving picture data, a starting location of each VOBU varies according to a region. In DVDs, the starting locations of the VOBUs are separately managed and information about the starting locations of the VOBUs must be updated every time new multiplexing is executed.

Further, since the contents of subpictures cannot not distinguished from one another, the subpictures cannot be properly used in some cases, for example, when two languages are to be output simultaneously, when only a subtitle is to be output without a moving picture in order to study the language corresponding to the subtitle, or when a moving picture is to be reproduced including a specific content or other information of the moving picture reproduced together with a subtitle.

Subtitle data may also be converted into a markup document instead of graphics data. A synchronized accessible media interchange (SAMI) is a language format used to express movie scripts or subtitles. The SAMI was originally developed to achieve a closed caption broadcasting for hearing disabled persons. However, the SAMI is currently used as a movie subtitle file. The subtitle file denotes a markup document file to interpret an original language in a moving picture file, such as, a movie having a “divx” format or the like, into a language of a country that uses the moving picture file and to output the interpreted language in synchronization with a moving picture frame. The markup document file for subtitles is typically stored and reproduced in a file name of an original moving picture file with a SMI extension. Hence, a reproducing apparatus must have a SAMI codec to reproduce the markup document file.

FIG. 2 illustrates an example of an SAMI file. Referring to FIG. 2, when a script is written in the SAMI file, the script can be easily manufactured and conveniently managed. Only a movie subtitle or a simple situation description based on a text or simple graphics data can be displayed according to a one-sided movie reproduction flow. In other words, a variety of information cannot be provided, and interactions with users cannot be made.

### SUMMARY OF THE INVENTION

The invention provides a markup language for movie scripts that improves user interaction, contributes to a proper display of a conventional subtitle or caption, enables a scene search, and provides other useful information. The invention provides an information storage medium that stores a scenario written in a markup language, an apparatus for reproducing data from the information storage medium, a method of searching the scenario, and an apparatus and/or method of recording audio/video (AV) data including a scenario in the information storage medium.

According to an aspect of the invention, there is provided an information storage medium that stores a scenario, the scenario including elements indicating components of the scenario and attributes indicating detailed information about the elements. Each of the elements is used upon a search of the scenario.

The scenario may be a markup document written using the elements as tags and the attributes as attribute values corresponding to the detailed information about the elements.

According to another aspect of the invention, there is provided an information storage medium that stores audio/video (AV) data, the information storage medium including moving picture data and a scenario of a moving picture. The scenario includes elements indicating components of the scenario and attributes indicating detailed information about the elements. Each of the elements is used upon a search of the scenario.

According to another aspect of the invention, there is provided an apparatus for reproducing data from an information storage medium, the apparatus including: a reader reading out moving picture data and scenario data from the information storage medium; a decoder decoding the moving picture data and outputting decoded moving picture data; a filter filtering out only desired information from the scenario data in response to a user command; a renderer rendering the filtered-out information into graphics data; a blender blending the decoded moving picture data with the graphics data and outputting a result of the blending; and a controller controlling the filter, the decoder, the renderer, and the reader.

According to another aspect of the invention, there is provided a method of searching a scenario, the method including: extracting components of a scenario using elements; displaying a search screen produced by applying a style sheet to the extracted elements; receiving a desired search condition from a user; and searching for a content from the scenario by using an element matched with the received search condition as a keyword and providing the searched content to the user.

According to another aspect of the invention, there is provided an apparatus for recording a scenario together with a moving picture in an information storage medium, the apparatus including: a characteristic point extractor extracting characteristic points from the moving picture; an element producer producing elements indicating components of the scenario based on the extracted characteristic points and allocating attribute values, which are detailed information about the produced elements, to the produced elements; and a metadata producer producing child elements of the elements, which correspond to sub-components of the scenario, from attribute information about the sub-components of the scenario received from a user.

According to another aspect of the invention, there is provided a method of recording a scenario together with a moving picture in an information storage medium, the method including: extracting characteristic points from the moving picture; producing elements indicating components of the scenario based on the extracted characteristic points and allocating attribute values, which are detailed information about the produced elements, to the produced elements; and producing child elements of the elements, which correspond to sub-components of the scenario, from attribute information about the sub-components of the scenario received from a user.

According to another aspect of the invention, there is provided a computer-readable recording medium that stores a computer program for executing the above-described method.

### BRIEF DESCRIPTION OF THE DRAWINGS

The above and/or other features and advantages of the invention will become more apparent by describing in detail exemplary embodiments thereof with reference to the attached drawings in which:

FIG. 1 is a block diagram of a structure of a video object set, which is encoded moving picture data recorded on a digital video display;

FIG. 2 illustrates an example of a synchronized accessible media interchange file;

FIG. 3 is a table showing elements and attributes used in a markup language according to an embodiment of the invention;

FIG. 4 illustrates an example of a scenario used upon manufacture of a movie;

FIG. 5 illustrates a movie script markup language document of the invention into which the scenario of FIG. 4 is written;

FIG. 6 is a block diagram of a reproducing apparatus for reproducing a script written into a movie script markup language document of the invention;

FIG. 7 is a block diagram of a controller shown in FIG. 6;

FIG. 8 illustrates an example of a search screen enhanced with reference to a movie script markup language document by a reproducing apparatus;

FIG. 9 illustrates a scene search screen;

FIG. 10 illustrates a location search screen;

FIG. 11 illustrates a screen for movie script search;

FIG. 12 is a flowchart illustrating a scenario search method according to an embodiment of the invention;

FIG. 13 is a block diagram of an audio/video (AV) data recording apparatus according to an embodiment of the invention;

FIG. 14 illustrates a screen on which elements scene are displayed;

FIG. 15 illustrates a screen for metadata generation; and

FIG. 16 illustrates a metadata input screen displayed when a location category is selected.

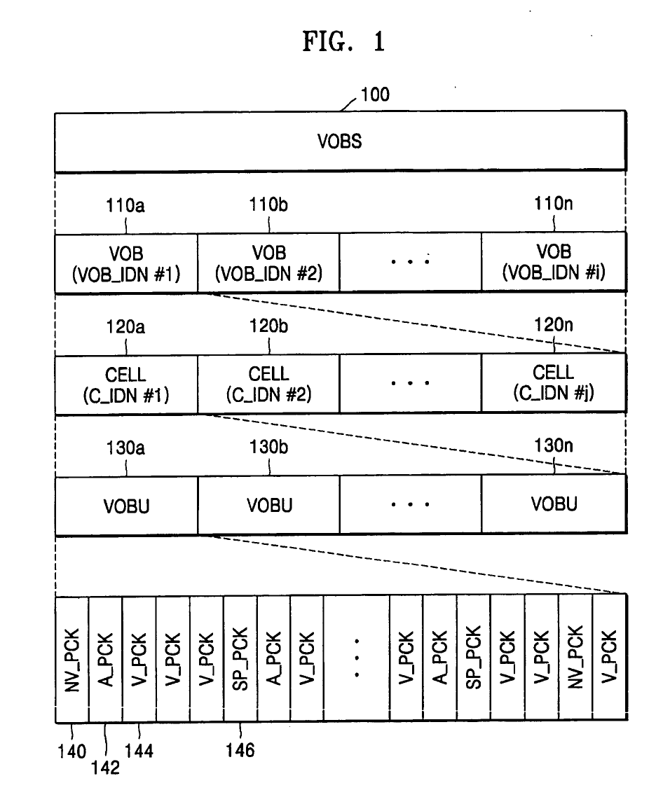

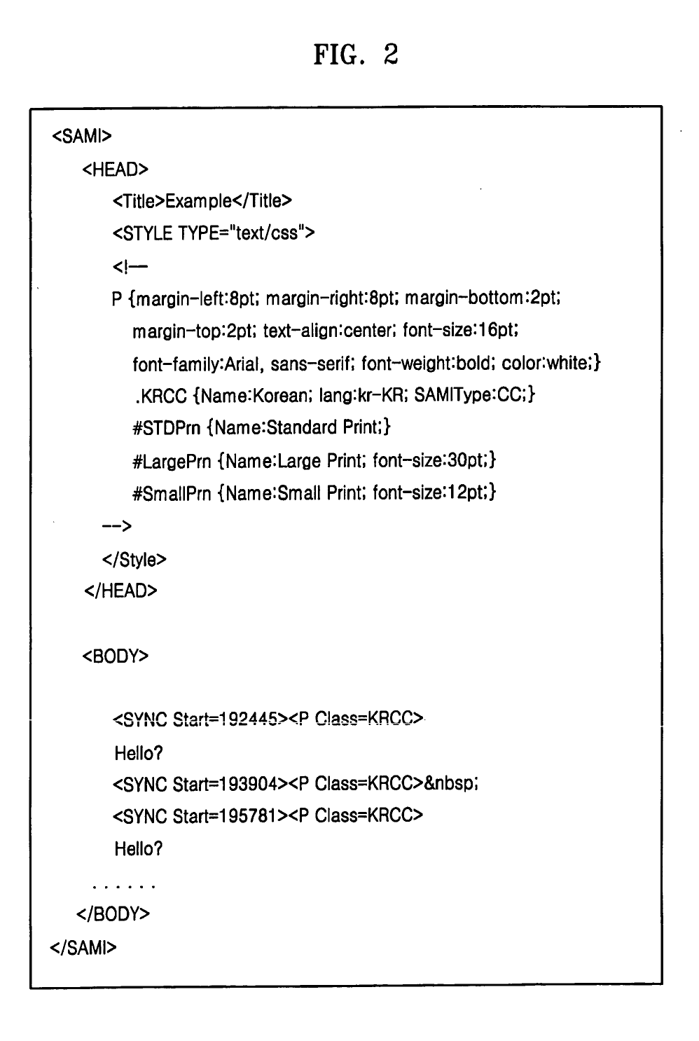

### DETAILED DESCRIPTION OF THE PREFERRED EMBODIMENTS

A scenario is a script that is written with sentences based on a movie format in a movie making process and is projected on a screen. Before displaying a movie, the scenario writing is very important in order to specify audiovisual depictions of the movie using letters. Since a movie includes a number of scenes, division and composition of a scene are important in writing a scenario. Descriptions of scenes are also important in preparing an actors' or actresses' dialogs.

Personal computers are able to display movies of good quality that are displayed on DVDs and a scenario, together with a continuity (which is abbreviated as a conti) that is provided in the name of a movie script upon display of a PC movie. A conti denotes a scenario for movie photographing and stores all ideas and plans about the movie photographing.

A movie script including a scenario and/or a conti provided upon display of a PC movie generally includes a title of a movie; scene identifiers, scene numbers, and scene titles; the locations where the scenes are photographed; descriptions on the scenes; dialogs of movie actors and actresses; the names of characters played by actors and actresses on each scene and the names of the actors and actresses; a brief description about behaviours of the actors and actresses; information about effect music and background music; and a representative image (i.e., a conti) about each scene.

In a method of displaying a subtitle using such a movie script, at least the aforementioned contents are provided to a user using a simple image and a simple text, such that more information is provided to the user than a method of converting a subtitle into graphics data. However, in the former method, information for interactions with the user cannot be provided to the user. A markup language used to effectively provide the movie script enables user interaction and provides the following additional information: information about properties used in each scene, additional information about a location where each scene is photographed, and movie version information about each scene (e.g., a theatre, a director's cut, and the like).

Hence, in a markup document, the above pieces of information are classified according to at least their elements and attributes. The classified information pieces may be all displayed on a screen or only dialogs of actors or actresses may be displayed on the screen as a subtitle. Accordingly, an element including the dialogs of actors or actresses preferably includes time information for synchronizing the dialogs of the actors or actresses with moving pictures in real time.

Elements other than the element to be synchronized with a moving picture in real time like the actors' or actresses' dialogs do not need time information for the synchronization but may need time information for scenes included in the elements. Additional information may be written as a content of a corresponding element. Link information in which a specific page including a detailed description or the like can be referred to may also be included in a corresponding element. The aforementioned information may be displayed on a screen in different styles using information about styles of the aforementioned information.

In an aspect of a movie script using the markup document, all actors' or actresses' dialogs can be displayed on a screen in a predetermined style, such as scrolling or the like, since an element including the actors' or actresses' dialogs also includes time information for synchronization with moving pictures. When a user selects a location where a specific dialog is to be displayed, a reproducing apparatus reproduces a moving picture to be synchronized with the dialog selected by the user by referring to the time information included in the above element.

The numbers or titles of all scenes, descriptions thereof, and the like can be displayed on a screen, and a specific scene can then be selected by a user and displayed on the screen.

The names of photographing locations are sequentially displayed, and a specific photographing location can be selected therefrom so that either a scene corresponding to the selected photographing location can displayed or additional information about the selected photographing location, for example, famous sightseeing places, can be displayed on the screen.

Information about properties used by actors or actresses is displayed, and a specific property can be selected therefrom so that either a scene corresponding to the selected property can be displayed or information about a purchase or description of the selected property, for example, can be provided to a user.

A scene where a specific background music is played, additional information about the specific background music, and the like can be provided to a user. As described above, an element and an attribute of each information can be used in a reproduction apparatus or the like that is capable of providing useful information through interactions with a user using the markup language.

Instead of using a single element or attribute to obtain a specific scene or additional information as described above, a plurality of elements or attributes may be logically combined and displayed to provide a more accurate specific scene or more accurate addition information.

In other words, the markup document classifies possible factors included upon scenario and/or conti writing according to element, and pieces of information or contents corresponding to each element are included in an attribute of the element or as the contents of the element. To provide a specific scene selected by a user or additional information, each of the elements including time information for synchronization with moving pictures or information associated with the specific scene also includes time information about the specific scene and link information about the additional information.

The markup document for the above-described movie script can serve as only a database, and information about display is displayed on a screen using style information for markup documents, such as Cascading Style Sheets (CSS) or the like. Further, the style information, used to display a markup document for a movie script on a display device, may include movie script viewing information that defines a location where to display each element, font properties, and the like.

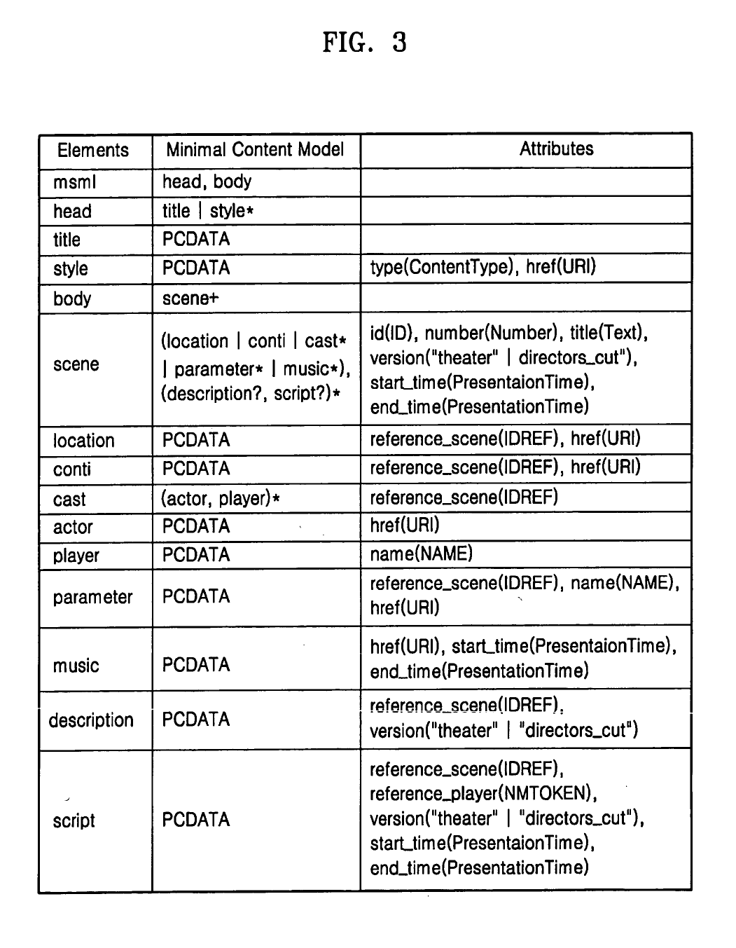

FIG. 3 is a table showing elements and attributes used in a markup language according to an aspect of the invention. Referring to FIG. 3, a movie script markup language (MSML), which is the markup language, uses elements and attributes. Semantics of the elements and attributes are described below with reference to FIG. 3.

An element msml is a root element of an MSML document. In other words, every MSML document starts with the element msml.

An element head includes information, such as a title of a current document. Contents included in the element head are not always displayed on a display device, but may be displayed on the display device depending on characteristics of a browser. Referring to FIG. 3, the element head includes element title and element style. The element title must exist in the element head, and the element style exists therein depending on a purpose of a manufacturer.

An element title, which is included in the element head, is used to include a title of a movie script with which the manufacturer deals in the current document. A single element title is used in the MSML document.

An element style helps the manufacturer to include a style sheet rule including movie script viewing information in the element head. A plurality of elements style may be included in a head of the MSML document. The element style is attribute information and includes at least two attributes, which are type and href.

The attribute type is used to designate a language in which a style sheet is written with the contents of the element style. The style sheet language is designated to have a content type, such as, “text/css”, and the manufacturer must write a value of this attribute in the MSML document.

The attribute href is used to refer to an external document written in a style sheet language. When the referred external style sheet document has contents overlapped by a style sheet document written using the element style, the external style sheet document is used. The attribute href is used depending on a manufacturer's decision, and a uniform resource identifier is used as a value of this attribute.

An element body includes contents of the MSML document that can be displayed on a browser. Referring to FIG. 3, the element body includes at least one element scene.

An element scene is a fundamental element in a scenario and corresponds to scenes. The MSML document includes several elements scene. Each of the elements scene may include several sub-elements, such as, element location, element conti, element cast, element parameter, element music, element description, and element script. Element scene has at least 6 attributes, as follows.

An attribute id denotes an identifier of a document. Element scene must include this attribute, wherein each element scene has a unique attribute value.

An attribute number denotes a number allocated to a scene in a scenario and is not necessarily included in the element scene.

An attribute title denotes a title allocated to a scene. The attribute title is not necessarily included in the element scene.

An attribute version indicates whether a scene is either a scene to be shown in a theater or a director's cut. This attribute has attribute values of “theater” and “directors_cut”. If attribute version is not included in the element scene, the version of a scene is recognized as “theater”.

An attribute start_time denotes the time when a moving picture corresponding to a scene starts being presented. The attribute start_time has an attribute value, which is either a presentation time stamp (PTS), indicating the time at which a moving picture is presented, or a time value in units of 1/1000 of a second. In FIG. 3, the attribute start_time attribute has a PTS as its attribute value.

An attribute end_time denotes the time when a moving picture corresponding to a scene is changed to a moving picture corresponding to another scene. Similar to the attribute start_time, the attribute end_time has an attribute value, which may be either a PTS or a time value in units of 1/1000 of a second. A value of attribute end_time of a scene and a value of attribute start_time of a next scene may be consecutive.

An element location is used to include information about a place where a scene is photographed in the current MSML document. Because one location is used for one scene, the element scene includes a single element location. This element includes at least two attributes, such as, reference_scene and href.

The attribute reference_scene indicates which scene a photographed place described by element location corresponds to. The attribute reference_scene attribute must exist in the location element and uses an attribute value used in the attribute id of element scene as its attribute value. For example, the attribute reference_scene may be used when a specific reproducing apparatus must display only a content corresponding to element location found from an MSML document using an enhanced search of the invention on a screen and then reproduce a moving picture corresponding to a photographed place selected by a user.

The reproducing apparatus can recognize the element scene corresponding to an attribute value of referred attribute reference_scene of element location and reproduce a moving picture corresponding to the selected photographed place at a point in time indicated by an attribute value of attribute start_time of the element scene. However, when a specific scene is searched for using only the element location, a found photographed location may have several scenes, so element location is logically combined with other elements to search for an exact scene.

The attribute href is used to refer to an external document including additional information about a photographing place of a certain scene. The attribute href uses a uniform resource identifier (URI) as its attribute value. If a specific reproducing apparatus can reproduce an external document including information about sightseeing places, restaurants, shopping places, and the like close to a photographed place as additional information about the photographed place, the external document including the additional information can be displayed on a screen in response to a selection of a user. Use of the attribute href is determined by a manufacturer of the scenario.

An element conti refers to a conti sketched for photographing after scenario writing. The element conti element may not be used in an MSML document including no conti contents and has at least the following attributes.

An attribute reference_scene of element conti indicates a photographed place corresponding to a scene indicated by a description and an image on a conti referred to by element conti. The attribute reference_scene exists in the element conti. An attribute value of the attribute reference_scene is the attribute value used in the attribute id of the element scene. An example of the use of the attribute reference_scene is the same as that of the attribute refrence_scene of the element location.

An attribute href indicates a path along which an image conti about a certain scene is referred to. The attribute href uses a URI as its attribute value and must exist in the element conti.

An element cast is used to include contents regarding a cast of players appearing on a certain scene in the current MSML document. The element cast includes element actor and element player. If no players appear on a scene, element cast may not be included in the current MSML document. The element cast has an attribute of reference_scene.

The attribute reference_scene of the element cast indicates which scene actors and players included by element cast appear on. The attribute reference_scene exists in the element cast and has the same attribute value as that used in the attribute id of the element scene. An example of the use of the attribute reference_scene is the same as that of the attribute reference_scene of the element location. However, when a specific scene is searched for using only element cast, several scenes may be found if an actor (actress) or a player to be found is a central figure or a major character, so element cast is preferably logically combined with other elements to search for an exact scene.

An element actor is used to include a name of an actor (actress) who acts as a player on a certain scene to be indicated by element player. This element includes an attribute, that is, an attribute href.

The attribute href is used to refer to an external document that describes in detail actors (actresses) included by element actor. The attribute href uses a URL as its attribute value and use or non-use of attribute href is determined by a manufacturer of the scenario.

An element player is used to include in the current MSML document names of players played on the certain scene by the actors (actresses) included by element actor. This element includes an attribute, that is, an attribute name.

An attribute name indicates a name allocated to a current element player. This name is used by element script referring to a name of a player.

An element parameter is used to include in the current MSML document information about properties or actors' (actresses') costumes used on a current scene. This element may include at least the following three attributes.

An attribute reference_scene that indicates which scene the properties or the costumes included by the element parameter appear on. The attribute reference_scene exists in the element parameter and has the same attribute value as that used in attribute id of the element scene. An example of the use of the attribute reference_scene is the same as that of the attribute reference_scene of the element location. However, when a specific scene is searched for using only the element parameter, the properties or the costumes to be found may appear on several scenes, so the element parameter is logically combined with other elements to search for an exact scene.

An attribute name is used to classify properties or costumes indicated by element parameter into some categories. The attribute name has a plurality of categories as its attribute values. Examples of the categories include a weapon, a costume, a car, and the like.

An attribute href is used to refer to an external document that includes a detailed description about an interest property or costume. The attribute href uses a URI as its attribute value.

An element music is used to provide information about effect sounds, background sounds, or the like played in an interest scene. This attribute has at least the following 3 attributes.

An attribute href to refer to an external document including a detailed description of an interest music. The attribute href uses a URI as its attribute value.

An attribute start_time indicates a time when an interest music starts playing within a moving picture. The attribute start_time has an attribute value, which may be either a presentation time stamp (PTS), indicating the time at which a moving picture is presented, or a time value in units of 1/1000 of a second. As shown in FIG. 3; the attribute start_time has a PTS as its attribute value.

An attribute end_time denotes the time when an interest music ends within a moving picture. Similar to the attribute start_time, the attribute end_time has an attribute value, which may be either a PTS or a time value in units of 1/1000 of a second.

An attribute such as an attribute reference_scene is not included in the element music because a signal scene may have several music. In other words, if the attribute reference_scene is used when a user refers to element music to select and watch a part of a scene where a specific music plays, the whole scene including the selected music is always replayed from its beginning part. Hence, reproduction of the exact part of the scene that the user wants to watch is not guaranteed. Accordingly, element music has the attributes start_time and end_time instead of the attribute reference_scene. This feature is equally applied to each of the above-described elements when several locations, several continuities, or the like are used in a single scene.

An element description is used to include in the current MSML document a stage direction including a depiction of an interest scene, a description of actors' (actresses') behaviors, or the like. The element description has at least the following two attributes.

The attribute reference_scene indicates which scene a scene depicted by the element description, a description about characters' behaviors, and the like corresponds to. The attribute reference_scene must exist in the element description and has the same attribute value as that used in the attribute id of the element scene.

An attribute version indicates whether an interest stage direction is associated with either a scene to be shown in a theater or a director's cut. The attribute version has an attribute value of theater or directors_cut. If the attribute version is not included in the element description, an interest stage direction is basically recognized as being associated with a scene to be shown in a theater.

An element script is used to include in the current MSML document actual dialogs of actors (actresses) relating to an interest scene. The element script has at least the following 5 attributes.

An attribute reference_scene indicating which scene the actors' (actresses') dialogs included by the element script appear on. The attribute reference_scene must exist in the element script and has the same attribute value as that used in the attribute id of the element scene.

An attribute reference_player indicates which player dialogs included in the current MSML document by element script belong to. By having one of attribute values of attribute name of element player, the attribute reference_player can link a player with dialogs suitable for the player.

An attribute version indicates whether an interest dialog is either to be reproduced in a theater or a director's cut. The attribute version has an attribute value of either theater or directors_cut. If the attribute version is not included in element script, an interest dialog is basically recognized as a dialog to be reproduced in a theater.

An attribute start_time is used when a dialog included by the element script is used as a subtitle of a movie. More specifically, information about a point in time when the dialog included by the element script starts being reproduced is needed so that the dialog can be displayed on a screen at an appropriate time point in synchronization with a moving picture, and the attribute start_time provides the information about the time point when the dialog reproduction starts. The attribute start_time has an attribute value, which may be either a presentation time stamp (PTS), indicating the time point at which a moving picture is presented, or a time value in units of 1/1000 of a second. In FIG. 3, the attribute start_time has a PTS as its attribute value.

An attribute end_time indicates a time point when a dialog included by element script disappears from a screen in synchronization with a moving picture. Similar to the attribute start_time, the attribute end_time has an attribute value, which may be either a PTS or a time value in units of 1/1000 of a second.

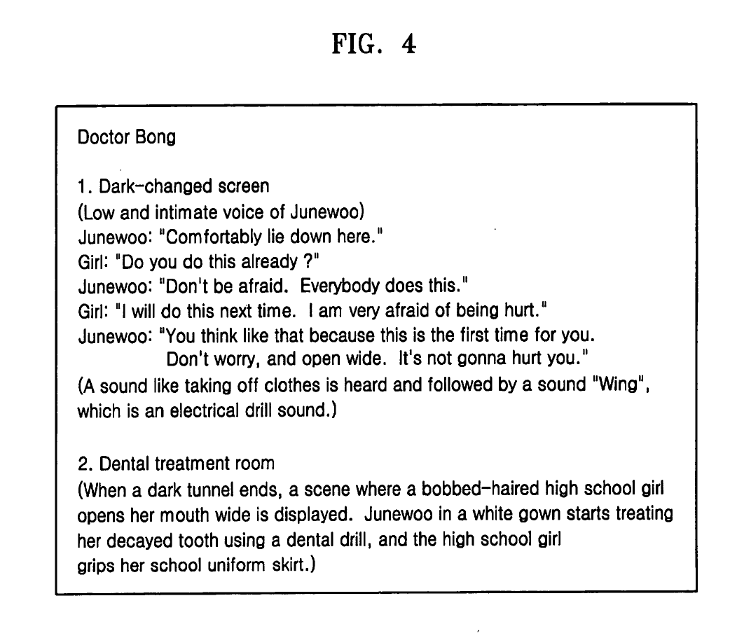

FIG. 4 is an example of a scenario used upon manufacture of an actual movie. Referring to FIG. 4, the scenario includes titles and backgrounds of scenes, behaviors and dialogs of actors (actresses), and the like.

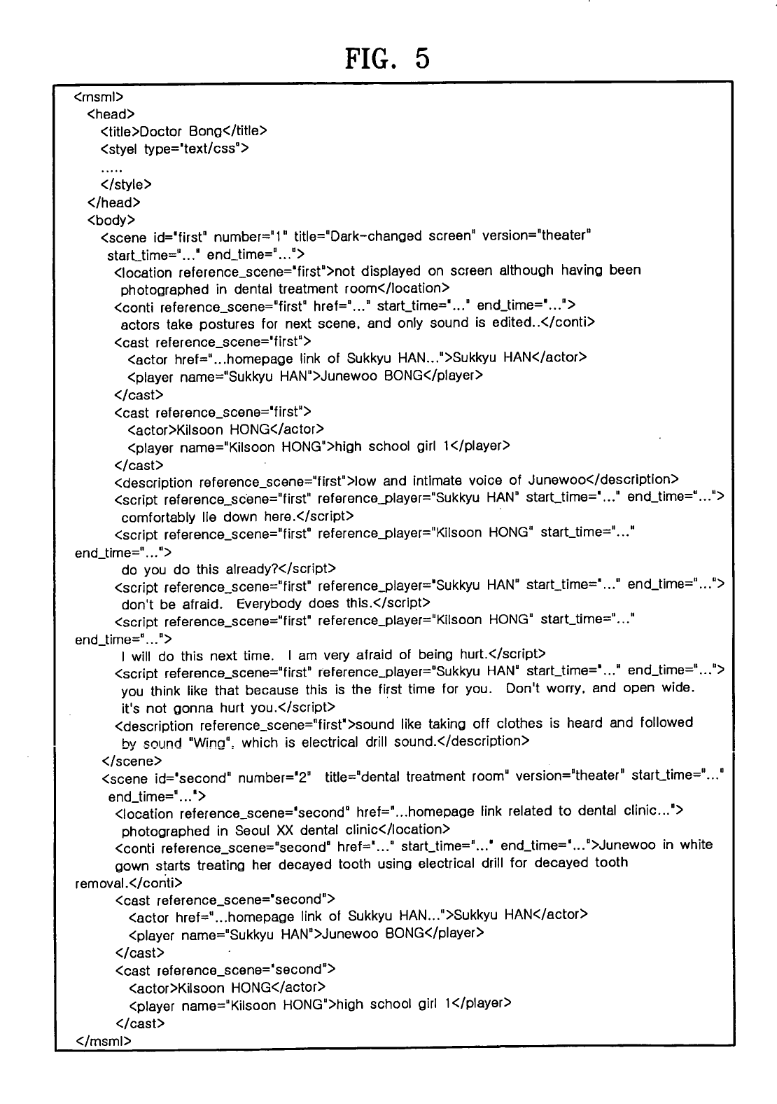

FIG. 5 illustrates an MSML document of the invention into which the scenario of FIG. 4 is written. Referring to FIG. 5, a style of the MSML document is represented by element style. When a style of the MSML document is represented on the MSML document as illustrated in FIG. 5, a document manufacturer or a reproducing apparatus can apply the style using a variety of methods. Hence, although not described in the present aspect, a style grammar also includes the aforementioned movie script viewing information.

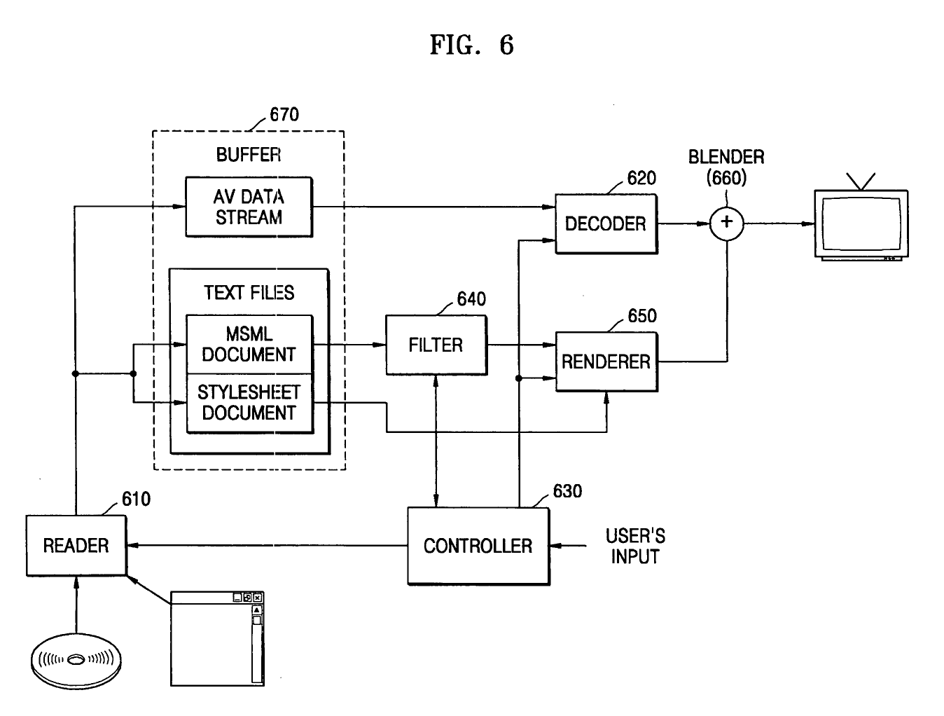

FIG. 6 is a block diagram of an apparatus for reproducing a script written into an MSML document of the invention from an information storage medium. The reproducing apparatus includes a reader 610, a decoder 620, a controller 630, a filter 640, a renderer 650, a blender 660, and a buffer 670.

The reader 610 reads out AV data stored in the information storage medium, a markup document for movie scripts stored in the information storage medium or a web, and style sheet text data including information about a style of the markup document. The decoder 620 decodes an AV data stream corresponding to the read-out AV data. In response to a command, the controller 630 controls the filter 640, the decoder 620, the renderer 650, and the reader 610. The filter 640 filters out a specific part from the MSML document in response to a control command output by the controller 630. The renderer 650 renders a filtered MSML document into a form displayable on a screen using the style sheet text data. The blender 660 blends a moving picture output by the decoder 620 with movie script data output by the renderer 650.

The buffer 670 buffers data transmitted to or received from the reader 610, the decoder 620, and the renderer 650. When a data-reading speed and a data-transmitting and processing speed are sufficiently high, the buffer 670 can be omitted.

More specifically, rendering denotes all operations necessary for a conversion of the markup document for movie scripts into graphics data that can be displayed on a display device. In other words, a font matched with a character code for each character in text data of the markup document is searched for from download font data read out from the information storage medium and/or the web or resident font data pre-stored in the reproducing apparatus and then converted into graphics data. This process repeats to form graphics data that organize a subtitle image or a movie script. Designation or conversion of a color, designation or conversion of a character size, a character size, appropriate making of graphics data depending on a horizontal writing or a vertical writing, and the like are also included in the operations necessary for the conversion of text data into graphic data.

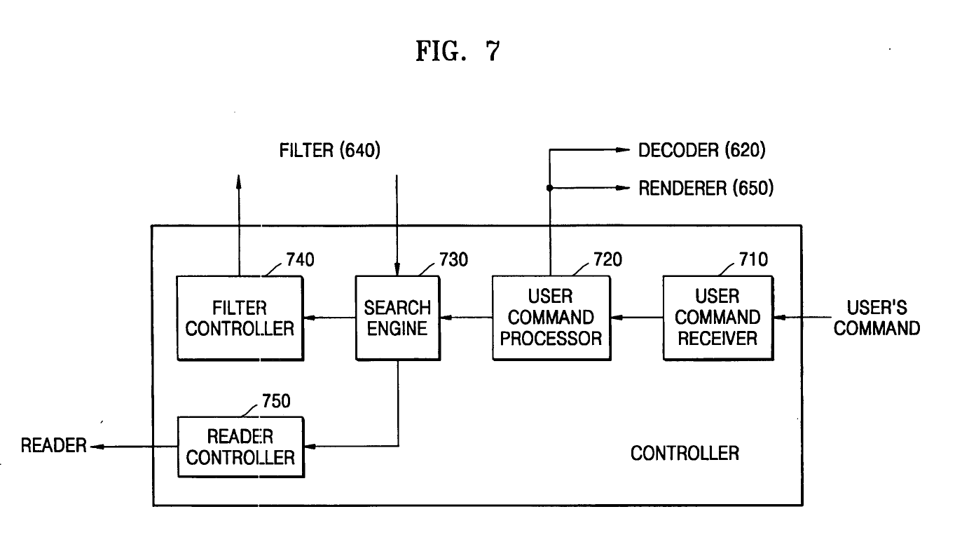

FIG. 7 is a block diagram of the controller 630. Referring to FIG. 7, the controller 630 includes at least a user command receiver 710, a user command processor 720, a search engine 730, a filter controller 740, and a reader controller 750.

The user command receiver 710 receives a command, for example, from a user. The user command processor 720 processes the user command. The search engine 730 searches for contents required by the user command from contents received from the filter 640. The filter controller 740 controls the filter 640 so that only the contents found by the search engine 730 are filtered out. The reader controller 750 controls the reader 610 so that a scene corresponding to a moving picture selected by the user are read out.

The user command receiver 710 receives a user input made pursuant to a user input device and transmits the user input to the user command processor 720. The user command processor 720 determines a type of the user command. When the user input is a command to control the AV data stream, the user command processor 720 transmits the user input to the decoder 620. When the user input is a command to control the MSML document, the user command processor 720 transmits the user input to the renderer 650. When the user input is data for enhanced search or a command to search for and reproduce a specific moving picture scene, the user command processor 720 transmits the user input to the search engine 730, which refers to the contents filtered out by the filter 640.

The search engine 730 searches for the contents (data) required by the user input (command) from the contents received from the filter 640 and transmits the found contents to the filter controller 740. The search engine 730 also controls the reader controller 750 so that necessary data can be read out. The filter controller 740 transmits movie script filtering information to the filter 640 so that the data found by the search engine 730 can be displayed.

In other words, the search engine 730 is included in the controller 630 to provide a type of an enhanced search service to the user and controls the filter 640 so that elements on the MSML document are filtered out according to a search strategy. The controller 630 controls the reader 610 and the renderer 650 so that a desired scene can be displayed on the display device by referring to attribute start_time or attribute reference_scene of the elements filtered out by the filter 640. The renderer 650 provides a new search screen using a displayable style sheet provided by a manufacturer or style sheet information stored in the reproducing apparatus, by referring to attributes of the filtered-out elements and contents.

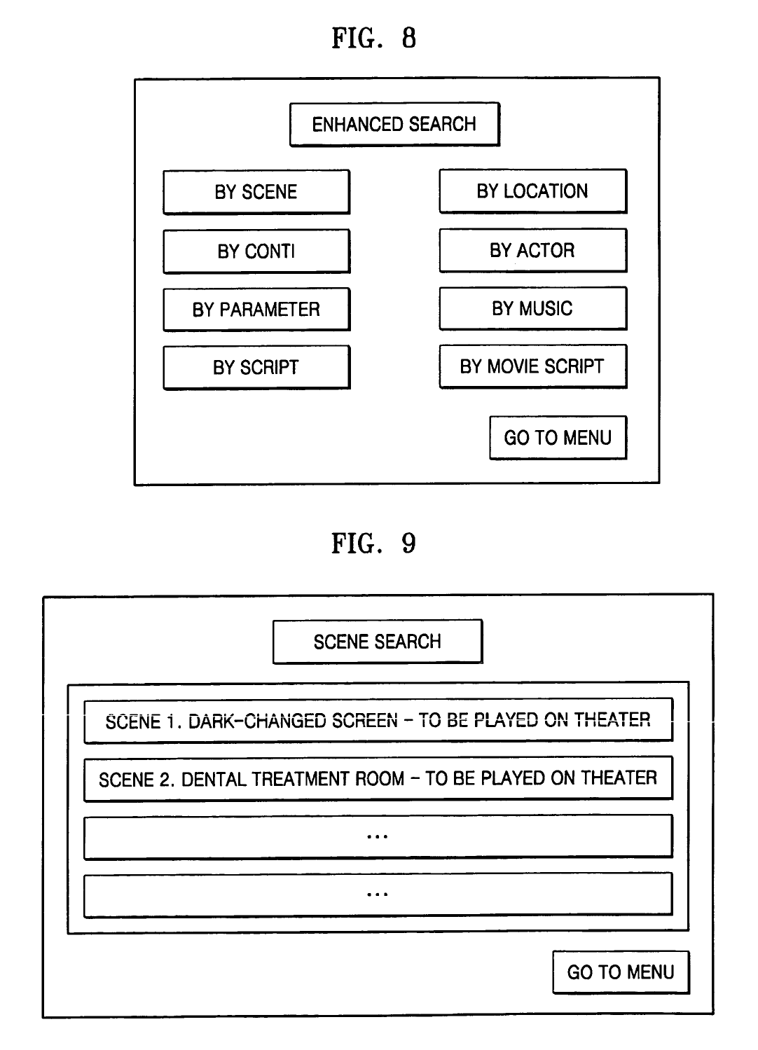

An example of an enhanced search using an MSML document performed in the reproducing apparatus is described below. Conventionally, to obtain a search screen as is shown in FIGS. 8 through 11, data used for searching must be manufactured into such a menu form by the scenario manufacturer and then stored on the information storage medium. However, the reproducing apparatus can obtain such a search screen as illustrated in FIGS. 8 through 11 on a screen by referring to an MSML document, without the need for the manufacturer to directly manufacture the menu.

FIG. 8 illustrates an example of an enhanced search screen obtained by the above-described reproducing apparatus with reference to an MSML document. Since the MSML document is a database in which parts used in a scenario or a conti are classified by elements and attributes using the MSML, the reproducing apparatus displays the search screen of FIG. 8 and provides elements usable for scene selection, such as, a scene, a location, a conti, an actor, a parameter, music, and a script element, as search bases to a user. A button “by movie script” is included on the search screen of FIG. 8, so the entire MSML document can be used as a search range. A style sheet used in a search using the entire MSML document as a search range may be manufactured by the document manufacturer and stored on the information storage medium during a manufacture of the information storage medium. Alternatively, the reproducing apparatus may store style sheet information about each of the elements.

The button “by scene” is included on the search screen of FIG. 8 to search for a screen for scene search, a reproducing apparatus produces such a screen as illustrated in FIG. 9 using a series of processes to be described below.

FIG. 9 illustrates a scene search screen. A controller of a reproducing apparatus receives a user input of “by scene” and searches for only information corresponding to a scene element from an MSML document filtered by a filter, and produces the scene search screen, displaying scene numbers and brief descriptions of scenes in a style indicated by the MSML document by referring to attributes of the scene element. When a user selects a specific scene number from the scene search screen of FIG. 9, a scene corresponding to the selected scene number can be reproduced with reference to attribute start_time of the scene element.

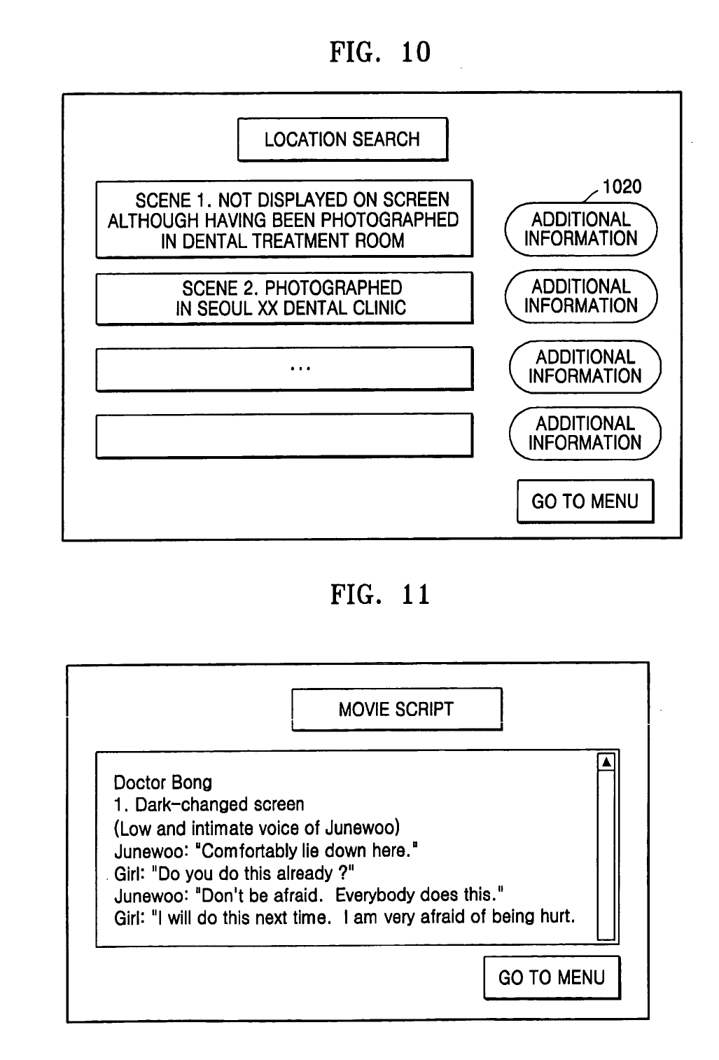

FIG. 10 illustrates a location search screen. The button “by location” is included on the screen of FIG. 8 to reproduce a desired scene corresponding to a searched photographed location, the location search screen of FIG. 10 is displayed. The screen of FIG. 10 is also produced with reference to attributes and contents of a location element by undergoing the processes described above in FIG. 9. When it is determined from attribute href of element location that additional information about a desired location is included in an external document, the additional information can be reproduced by clicking a button 1020 named “additional information” on the screen of FIG. 10. When selecting a specific photographed location from the location search screen of FIG. 10, the controller of the reproducing apparatus searches for a scene element including a location element corresponding to the selected photographed location by referring to attribute reference_scene of the location element so that a scene corresponding to the selected photographed location is reproduced with reference to attribute start_time of the searched scene element. This scene-reproduction method is equally applied to all elements that do not use attribute start_time.

FIG. 11 illustrates a screen for movie script search. The button “by movie script” is included on the screen of FIG. 8 to display all contents of the MSML document, as illustrated in FIG. 11. The user can select a specific scene, a specific stage direction, a specific dialog, or the like using screen scrolling or the like to watch a desired scene.

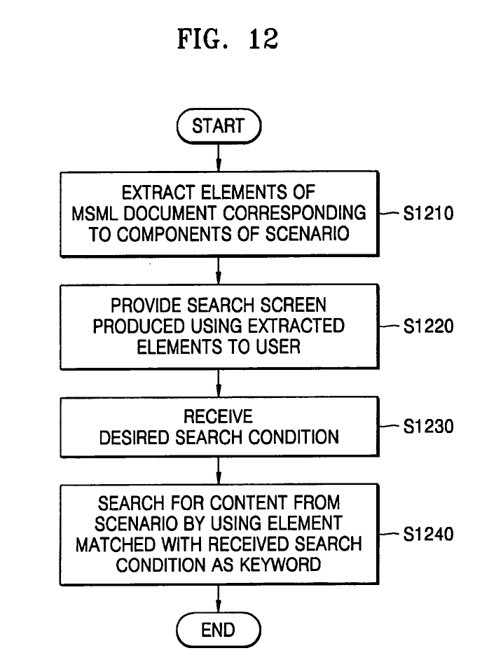

FIG. 12 is a flowchart illustrating a scenario search method according to an aspect of the invention. In operation 1210, elements of an MSML document corresponding to components of a scenario are extracted. In operation 1220, a search screen produced by applying a style sheet to the extracted elements is provided to a user. In operation 1230, a desired search condition is received from the user. In operation 1240, a content of the scenario is searched for by using an element matched with the received search condition as a keyword and provided to the user. The scenario search method may further include an operation of receiving an additional search condition input on the search screen by the user and displaying an element matched with the additional search condition input by the user.

The element selected by the user may include attributes start_time, end_time, and refrence_scene. A scene corresponding to the selected element may be controlled according to the attribute start_time and then played. Alternatively, a further scene search is performed by referring to the attribute reference_scene of the selected element, and then reproduction of a further searched scene is controlled according to attribute start_time of the searched screen.

The above-described metadata for search are produced by a contents manufacturer and stored together with a moving picture in an information storage medium. When a user stores a received moving picture in an information storage medium using an apparatus for recording an external moving picture in an information storage medium, the recording apparatus can record the metadata together with the moving picture in the information storage medium.

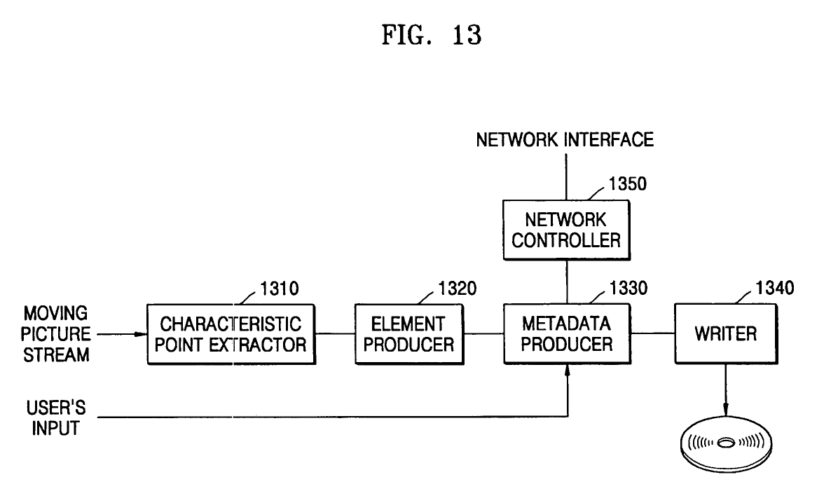

FIG. 13 is a block diagram of an audio/video (AV) data recording apparatus according to an aspect of the invention. This AV data recording apparatus includes a characteristic point extractor 1310, an element producer 1320, a metadata producer 1330, a writer 1340, and a network controller 1350.

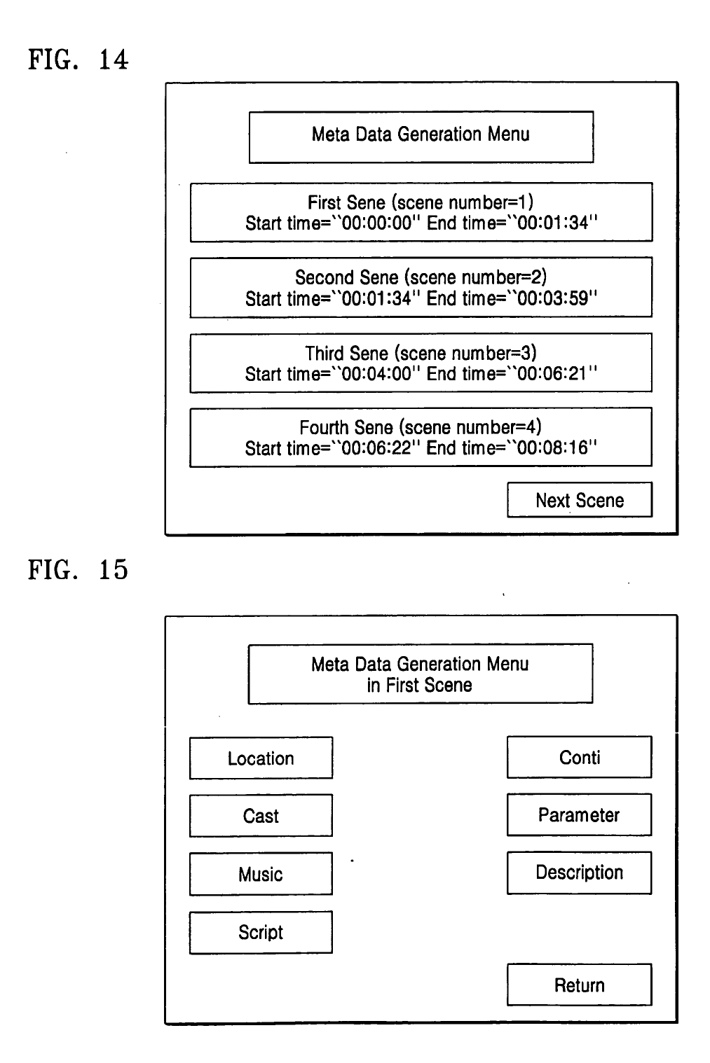

The characteristic point extractor 1310 extracts characteristic points from a received moving picture. The element producer 1320 produces elements indicating components of a scenario based on the extracted characteristic points and allocates attribute values, which are detailed information about the produced elements, to the produced elements. The metadata producer 1330 receives child elements of the elements and attribute information about the child elements from a user to produce sub-components of the scenario. The writer 1340 writes the sub-components of the scenario in the information storage medium. The network controller 1350 transmits the sub-components of the scenario to another device through a user interface. The network controller 1350 also receives metadata produced by another device. The element production and the metadata production will now be described in greater detail with reference to FIGS. 14 through 16.

The recording apparatus automatically produces elements corresponding to scenes of the elements of the metadata by extracting characteristic points from a moving picture to be recorded. The characteristic points denote points where important scenes, or predetermined scenes, are changed. Although the characteristic points are extracted while a moving picture is being processed, a method of extracting the characteristic points is not described herein. A scene between two adjacent characteristic points of the extracted characteristic points is matched with a scene element.

FIG. 14 illustrates a screen on which scene elements are displayed. The recording apparatus reads out a PTS of a moving picture frame corresponding to a present characteristic point while extracting the characteristic points and sets the PTS as an attribute value of attribute start_time of element scene and a PTS of a next characteristic point as an attribute value of attribute end_time of scene element. In this way, a plurality of scene elements can be produced using characteristic points extracted from the single moving picture. Based on an attribute value of attribute start_time of element scene, attribute values of other attributes id and number of scene element are determined. In other words, the recording apparatus can produce metadata to be used upon a chapter change from a moving picture to be recorded in an information storage medium.

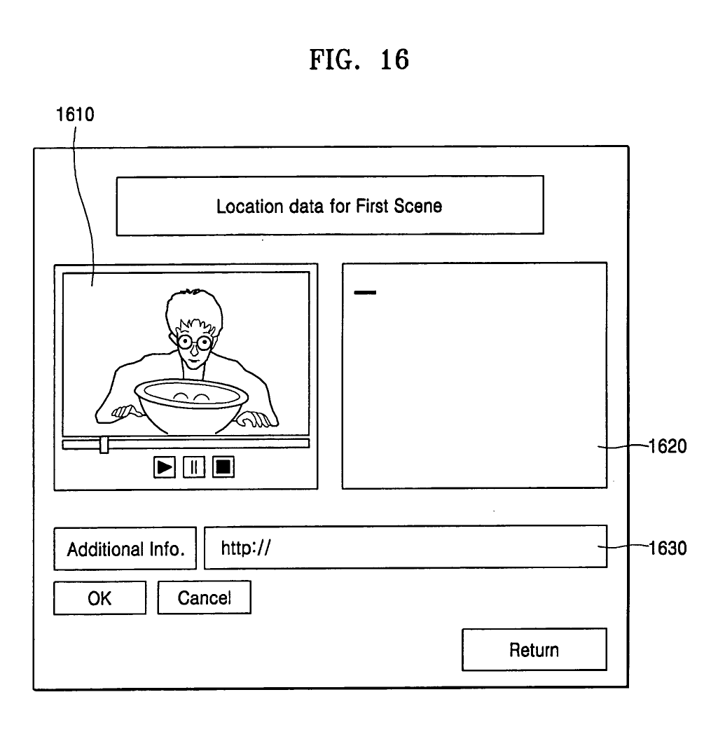

To produce other metadata, the recording apparatus receives data corresponding to sub-elements of element scene directly from a user. Metadata input and production will now be described in greater detail with reference to FIGS. 15 and 16.

FIG. 15 illustrates a screen for metadata generation. Referring to FIG. 15, when detailed information about a first scene needs to be further provided to a user, a metadata generation screen for the first scene enumerates types of metadata that can be included in a scenario by a user so that the user can input the detailed information using buttons corresponding to the metadata types. Hence, the user can include further information in the MSML document by selecting a category of the metadata corresponding to the further information from the screen.

FIG. 16 illustrates a metadata input screen displayed when a location category is selected. Referring to FIG. 16, the recording apparatus provides a moving picture window 1610, through which a user can input information about a photographed location while watching a moving picture corresponding to the first scene, a portion 1620, which receives a description of a location included in element location, and a portion 1630, which receives an attribute value of attribute href of the attributes of element location. In this way, attribute information about metadata other than the location metadata of FIG. 15 can be input by a user and stored in an information storage medium.

As described above, the recording apparatus extracts characteristic points from moving picture data and defines moving picture data between two adjacent characteristic points as a homogeneous clip, thereby producing a plurality of homogeneous clips. In each of the homogeneous clips, a PTS value, which is a time point when the homogeneous clip starts, and a representative image of the homogeneous clip may be included in the forms of MPEG-I. Also, additional metadata may be included in the form of predetermined elements and attributes as described above. Furthermore, an element that enables an arbitrary description of contents of the homogeneous clip may be included in the MSML document. Hence, the recording apparatus can provide information about an abstract of a movie to users.

A recording apparatus connectable to a network, such as an Internet, can transmit a metadata file manufactured as described above directly to a server or another recording apparatus through the network controller 1350. Accordingly, the recording apparatus is connected to a server and downloads metadata manufactured by another user or directly-received metadata in a memory area of the recording apparatus or in an information storage medium, so that various metadata can be utilized. Because such metadata can be edited and modified by other recording apparatuses, a user may manufacture his or her own metadata using metadata manufactured by other users. In this case, an element and an attribute that enable addition of information about the user to the metadata file may be further included in the MSML document.

As described above, a scenario and/or a conti are written in a markup language for movie scripts, so more various information is provided to users. Also, interactions with the users are improved, thereby providing various search methods.

Furthermore, when moving image data is to be recorded in an information storage medium, a scenario including arbitrary metadata manufactured by a user can be stored together with the moving image data in the information storage medium.

The invention can also be embodied as computer readable codes on a computer readable recording medium. The computer readable recording medium is any data storage device that can store data that can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An information storage medium that stores a scenario for a moving picture, the scenario comprising:
elements indicating components of the scenario; and
attributes indicating detailed information about the elements,
wherein each of the elements is used during a search of the scenario.

2. The information storage medium as claimed in claim 1, wherein the scenario is a markup document written using the elements as tags and the attributes as attribute values corresponding to the detailed information about the elements.

3. The information storage medium as claimed in claim 1, wherein the components of the scenario include at least one information selected from a group comprising:
properties appearing on each scene, costumes, a description of each photographed location, and additional information about dialogs.

4. The information storage medium as claimed in claim 1, wherein a dialog element is included in the elements and includes an attribute corresponding to presentation time information that is used to display a dialog in synchronization with the moving picture.

5. The information storage medium as claimed in claim 4, wherein the presentation time information is a presentation time stamp of the moving picture that is displayed in synchronization with the dialog.

6. The information storage medium as claimed in claim 1, wherein each of the elements includes moving picture presentation time information, which is information about a time point when the moving picture corresponding to the element is played, so that the element is searched for and a screen corresponding to the element is displayed.

7. The information storage medium as claimed in claim 1, wherein each of the attributes has an attribute value of a contents manufacturing version indicating whether contents corresponding to each of the elements are to be played on a theater display or a director's cut.

8. The information storage medium as claimed in claim 1, wherein each of the attributes includes information about a reference location where Internet information associated with each of the elements exists.

9. The information storage medium as claimed in claim 1, further comprising style information indicating a form in which the scenario is displayed.

10. The information storage medium as claimed in claim 9, wherein the style information is written in a style sheet language.

11. An information storage medium that stores audio/video data and is read by an apparatus for reproducing data, the information storage medium comprising:
moving picture data; and
a scenario of a moving picture,
wherein the scenario comprises:
elements indicating components of the scenario, and
attributes indicating detailed information relating to the elements,
wherein each of the elements is used upon a search of the scenario.

12. The information storage medium as claimed in claim 11, wherein the information storage medium is an optical disc.

13. The information storage medium as claimed in claim 11, further comprising reference link information relating to the scenario of the moving picture.

14. An apparatus for reproducing data from an information storage medium, the apparatus comprising:
a reader reading out moving picture data and scenario data from the information storage medium;
a decoder decoding the read moving picture data and outputting decoded moving picture data;
a filter filtering out desired information from the scenario data in response to a command;
a renderer rendering the filtered-out information into graphics data;
a blender blending the decoded moving picture data with the graphics data and outputting a result of the blending; and
a controller controlling the filter, the decoder, the renderer, and the reader.

15. The reproducing apparatus as claimed in claim 14, wherein the reader downloads the moving picture data and the scenario data from an Internet source.

16. The reproducing apparatus as claimed in claim 14, wherein the scenario data comprises:
elements indicating components of the scenario, wherein each of the elements is used during a search of the scenario; and
attributes indicating detailed information relating to the elements.

17. The reproducing apparatus as claimed in claim 15, wherein the scenario data is a markup document written using the elements as tags and the attributes as attribute values corresponding to the detailed information relating to the elements.

18. The reproducing apparatus as claimed in claim 14, further comprising:
a buffer temporarily storing the read-out moving picture data and the read-out scenario data.

19. The reproducing apparatus as claimed in claim 18, wherein the buffer stores text data corresponding to the scenario data and a style sheet document, which indicates information about a style in which the text data is displayed.

20. The reproducing apparatus of claim 19, wherein the buffer comprises a font storage buffer receiving information relating to a font matched with the text data from the reader during a receipt of the moving picture data and temporarily storing the font information.

21. The reproducing apparatus as claimed in claim 14, wherein the controller comprises:
a user command processor receiving the command and transmitting the command to an appropriate unit of the filter, the decoder, the renderer, and the reader depending on the type of the command;
a search engine searching the scenario in response to the command;
a filter controller controlling the filter according to a search condition produced by the search engine; and
a reader controller controlling the reader according to the search condition.

22. The reproducing apparatus as claimed in claim 21, wherein the controller further comprises:
a user command receiver receiving the command associated with a desired search condition.

23. The reproducing apparatus as claimed in claim 21, wherein the search engine receives all elements indicating components of the scenario through search conditions and searches the scenario according to the elements.

24. A method of searching a scenario for a moving picture, the method comprising:
extracting elements relating to components of the scenario;
displaying a search screen produced by applying a style sheet to the extracted elements;
receiving a desired search condition; and
searching for a content from the scenario by using an element matched with the received search condition as a keyword and displaying the searched content.

25. The method as claimed in claim 24, wherein the scenario comprises:
elements indicating components of the scenario; and
attributes indicating detailed information relating to the elements,
wherein each of the elements is used upon a search of the scenario.

26. The method as claimed in claim 24, further comprising:
receiving a further search condition input on the search screen; and
displaying an element matched with the further search condition.

27. The method as claimed in claim 26, further comprising:
displaying the element matched with the further search condition using time information indicating a time point when the moving picture corresponding to the element is played.

28. The method as claimed in claim 27, further comprising:
playing the time information, which is a presentation time stamp of the moving picture, in synchronization with the scenario.

29. A computer-readable recording medium that stores a computer program for executing a scenario searching method for a moving picture, the method comprising:
extracting elements relating to components of the scenario;
displaying a search screen applying a style sheet to the extracted elements;
receiving a desired search condition; and
searching for a content from the scenario by using an element matched with the received search condition as a keyword and displaying the searched content.

30. An apparatus for recording a scenario together with a moving picture on an information storage medium, the apparatus comprising:
a characteristic point extractor extracting characteristic points from the moving picture;
an element producer producing elements indicating components of the scenario based on the extracted characteristic points and allocating attribute values, which are detailed information about the produced elements, to the produced elements; and
a metadata producer producing sub-elements of the elements, which correspond to sub-components of the scenario, from attribute information about the sub-components of the scenario.

31. The recording apparatus as claimed in claim 30, further comprising:
a network controller transmitting metadata, including the sub-components of the scenario, to another device through a user interface or receiving metadata produced by another device.

32. The recording apparatus as claimed in claim 30, further comprising:
a writer writing metadata including the sub-components of the scenario in the information storage medium.

33. The recording apparatus as claimed in claim 30, wherein the characteristic point extractor extracts, as the characteristic points, points where scenes of the moving picture are changed.

34. The recording apparatus as claimed in claim 30, wherein the element producer produces elements, each of which have attributes corresponding to presentation time stamps indicating time points when scenes corresponding to the characteristic points start and time points when the scenes end.

35. The recording apparatus as claimed in claim 30, wherein the metadata producer receives the sub-elements of the elements and the attribute information relating to the sub-elements to produce sub-components of the scenario.

36. A method of recording a scenario together with a moving picture on an information storage medium, the method comprising:
extracting characteristic points from the moving picture;
producing elements indicating components of the scenario based on the extracted characteristic points and allocating attribute values, which are detailed information relating to the produced elements, to the produced elements; and
producing sub-elements of the elements, which correspond to sub-components of the scenario, from attribute information relating to the sub-components of the scenario received from a user.

37. The method as claimed in claim 36, further comprising:
extracting points where scenes of the moving picture are changed as the characteristic points.

38. The method as claimed in claim 36, further comprising:
allocating presentation time stamps indicating time points when scenes corresponding to the characteristic points start and time points when the scenes end as the attribute values.

39. The method as claimed in claim 36, further comprising:
receiving sub-elements of the elements and attribute information relating to the sub-elements to produce sub-components of the scenario.

40. A medium having a scenario that relates to at least one scene of a moving picture, the scenario comprising:
elements indicating components of the scenario; and
attributes indicating detailed information about the elements,
wherein a plurality of the elements or the attributes are logically combined and displayed to provide a specific scene.

41. The medium having the scenario as claimed in claim 40, further comprising:
a markup document to classify factors included upon the scenario according to each element, wherein information corresponding to each element is included in a respective attribute.

42. The medium having the scenario as claimed in claim 41, wherein each element includes time information for synchronization of the scenario with moving pictures or information associated with the specific scene.

43. The medium having the scenario as claimed in claim 41, wherein the markup document is a database storing information about the display.

44. The medium having the scenario as claimed in claim 41, wherein the elements and the attributes are written according to a movie script markup language.

45. The medium having the scenario as claimed in claim 44, wherein each element includes moving picture presentation time information, which is information about a time point when a moving picture corresponding to the element is played.

46. The medium having the scenario as claimed in claim 40, wherein the attributes comprise a start time attribute that denotes a scene start time and an end time attribute that denotes a scene end time.

47. The medium having the scenario as claimed in claim 40, wherein the attributes comprise an attribute that uses a uniform resource identifier to refer to an external document.

48. The medium having the scenario as claimed in claim 40, wherein the scenario includes subtitle data that is not converted into graphic data prior to encoding.

49. The medium having the scenario as claimed in claim 48, wherein the subtitle data is written in a SAMI language format.

50. The medium having the scenario as claimed in claim 40, wherein the medium is an optical disc information storage medium.

51. A method of automatically producing elements corresponding to scenes of a moving picture, the method comprising:
extracting characteristic points from the moving picture to be recorded; and
defining moving picture data between two adjacent characteristic points as a homogeneous clip, thereby producing a plurality of homogeneous clips,
wherein each homogeneous clip includes a value for a time point when the homogeneous clip starts.

52. The method of automatically producing elements as claimed in claim 51, further comprising
including a representative image of the homogeneous clip in an MPEG-1 format.

53. The method of automatically producing elements as claimed in claim 51, wherein the elements automatically produced includes an element to enable an arbitrary description of contents of the homogeneous clip.

54. The method of automatically producing elements as claimed in claim 51, wherein the scenes for the moving picture includes at least one scenario.

55. The method of automatically producing elements as claimed in claim 54, wherein each scenario for the moving picture is written in a movie script markup language.

56. The method of automatically producing elements as claimed in claim 55, wherein each scenario includes subtitle data that is converted into a markup document and is not converted into graphic data prior to encoding.

57. The method of automatically producing elements as claimed in claim 56, wherein the subtitle data is written in a SAMI language format.
